(19) United States
(12) Patent Application Publication
(10) Pub. No.: US 2019/0087931 A1
(43) Pub. Date: Mar. 21, 2019

(54) IMAGE PROCESSING APPARATUS AND IMAGE PROCESSING METHOD

(71) Applicants: Kabushiki Kaisha Toshiba, Tokyo (JP); Toshiba Electronic Devices & Storage Corporation, Tokyo (JP)

(72) Inventor: Takuya Ootani, Ota Tokyo (JP)

(21) Appl. No.: 15/899,476

(22) Filed: Feb. 20, 2018

(30) Foreign Application Priority Data
Sep. 15, 2017 (JP) 2017-177399

(51) Int. Cl. G06T 1/60; G06T 3/40

(52) U.S. Cl. CPC G06T 1/60; G06T 5/002; G06T 3/40

(57) ABSTRACT

According to one embodiment, an image generating process includes reading a first image from a memory; generating N-number of reduced images different in scale, from the first image; writing a first reduced image with a smallest scale of the reduced images into the memory; generating first filtered images by performing a filtering process to the first image and to a second reduced image or second reduced images of the reduced images excluding the first reduced image; and writing the first filtered images into the memory. A final image filtering process includes reading the first reduced image from the memory; generating a second filtered image by performing the filtering process to the first reduced image; and writing the second filtered image into the memory.

### CROSS-REFERENCE TO RELATED APPLICATIONS

This application is based upon and claims the benefit of priority from Japanese Patent Application No. 2017-177399, filed on Sep. 15, 2017; the entire contents of which are incorporated herein by reference.

### FIELD

An embodiment described herein relates generally to an image processing apparatus and an image processing method.

### BACKGROUND

In image processing that utilizes a conventional pyramid process, a Digital Signal Processor (DSP) generates a plurality of reduced images different in scale, on the basis of a single original image read from a memory. In this pyramid process, because a plurality of reduced images is generated, it takes time to perform the process. Further, because image data is exchanged between the DSP and the memory, a load is imposed on the bus that connects the DSP and the memory to each other.

### BRIEF DESCRIPTION OF THE DRAWINGS

FIG. 1 is a block diagram illustrating an example of a hardware configuration of an image processing apparatus according to an embodiment;

FIG. 2 is a block diagram schematically illustrating an example of a function configuration of a DSP according to the embodiment;

FIG. 3 is a flowchart illustrating an example of the sequence of an image processing method according to the embodiment;

FIG. 4 is a flowchart illustrating an example of the sequence of an image generating process;

FIG. 5 is a flowchart illustrating an example of the sequence of a final image filtering process;

FIGS. 6A to 6H are diagrams schematically illustrating an example of procedures for the image processing method according to the embodiment;

FIGS. 7A to 7H are diagrams schematically illustrating an example of procedures for the image processing method according to the embodiment; and

FIGS. 8A to 8H are diagrams schematically illustrating an example of procedures for an image processing method according to a comparative example.

### DETAILED DESCRIPTION

In general, according to one embodiment, an image processing apparatus includes a memory storing an image; an image processor performing a reducing or filtering process to the image read from the memory; and a bus transferring the image between the memory and the image processor. The image processor executes an image generating process and a final image filtering process. The image generating process includes reading a first image from the memory; generating N-number of reduced images different in scale (“N” is a natural number of 2 or more), from the first image; writing a first reduced image with a smallest scale of the reduced images into the memory; generating first filtered images by performing the filtering process to the first image and to a second reduced image or second reduced images of the reduced images excluding the first reduced image; and writing the first filtered images into the memory. The final image filtering process includes reading the first reduced image from the memory; generating a second filtered image by performing the filtering process to the first reduced image; and writing the second filtered image into the memory.

An exemplary embodiment of an image processing apparatus and an image processing method will be explained below in detail with reference to the accompanying drawings. The present invention is not limited to the following embodiment.

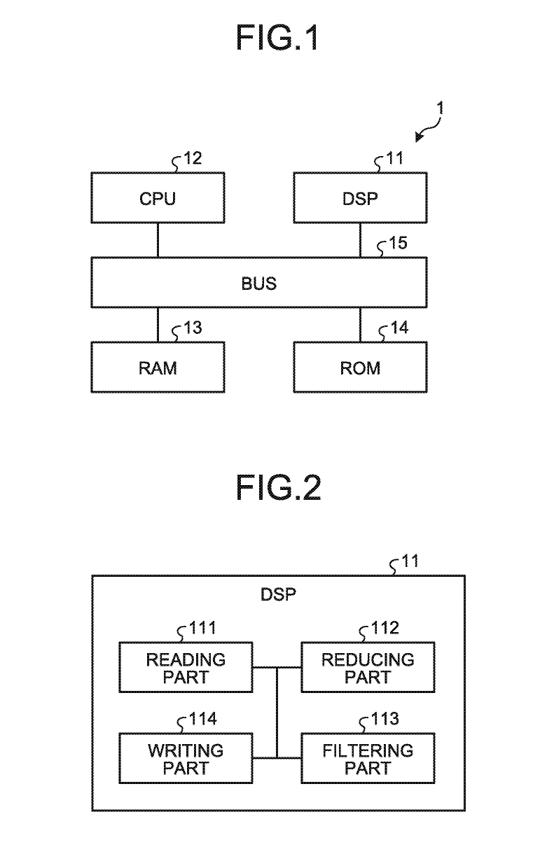

FIG. 1 is a block diagram illustrating an example of a hardware configuration of an image processing apparatus according to an embodiment. The image processing apparatus 1 includes a DSP 11, a Central Processing Unit (CPU) 12, a Random Access Memory (RAM) 13, and a Read Only Memory (ROM) 14. The DSP 11, the CPU 12, the RAM 13, and the ROM 14 are connected to each other by a bus 15. The image processing apparatus 1 having this configuration is achieved by an SoC (System-on-Chip), for example.

The DSP 11 is a microprocessor that performs image processing. The DSP 11 is an example of an image processor. In this embodiment, the DSP 11 executes an image generating process and a final image filtering process. In the image generating process, on the basis of a non-filtered single image (which will be referred to as “original image”, hereinafter), N-number of reduced images (“N” is a natural number of 2 or more), which have been reduced with different scales, are generated. Further, the original image and the reduced image or images other than the smallest-scale reduced image are subjected to filtering, by which filtered images are generated. Thus, the following images are generated from the single original image by the image generating process: N-number of filtered images different in scale, which exclude the smallest-scale reduced image and include the filtered original image; and the single smallest-scale reduced image.

In the final image filtering process, the smallest-scale reduced image generated by the image generating process is subjected to filtering, by which a filtered image is generated. The image generating process may be executed by an arbitrary number of repetition times, which is one or more. In any case, the final image filtering process is executed after the last round of the image generating process is executed.

For example, a state will be considered where five filtered images different in scale are obtained by performing the image generating process once. In a case where five filtered images different in scale are required, the image generating process is performed once, and then the final image filtering process is performed. In a case where ten filtered images different in scale are required, the image generating process is repeatedly performed twice. In this case, the second round of the image generating process uses as the original image the smallest-scale reduced image generated by the first round of the image generating process. Then, after the second round of the image generating process, the final image filtering process is performed.

FIG. 2 is a block diagram schematically illustrating an example of a function configuration of the DSP according to the embodiment. In order to perform the processes described above, the DSP 11 includes a reading part 111, a reducing part 112, a filtering part 113, and a writing part 114.

The reading part 111 reads an original image from a predetermined address of the RAM 13. When receiving an instruction of the image generating process, the reading part 111 gives the original image thus read to the reducing part 112. When receiving an instruction of the final image filtering process, the reading part 111 gives the original image thus read to the filtering part 113. Here, image reading may be performed by reading the image entirely at once, or may be performed by reading the image while dividing the image into tiles or lines.

When receiving the instruction of the image generating process, the reducing part 112 generates N-number of reduced images different in scale, from the original image read by the reading part 111. The number of reduced images to be generated is determined in accordance with their use. Here, it is assumed that the original image is reduced by R1 times, R2 times, R3 times, R4 times, and R5 times. In this case, it is satisfied that 1>R1>R2>R3>R4>R5. However, the reduction scale factors can be set to arbitrary scale factors. Further, the reducing part 112 outputs the original image with the original scale and the (N−1)-number of reduced images excluding the smallest-scale reduced image to the filtering part 113, and gives the smallest-scale reduced image to the writing part 114.

When receiving the instruction of the image generating process, the filtering part 113 generates N-number of filtered images by performing a desired filtering process to the original image and the (N−1)-number of reduced images excluding the smallest-scale one of the N-number of reduced images, which have been given from the reducing part 112. The filtering part 113 gives the five filtered images to the writing part 114. The desired filtering process may be exemplified by a high-frequency enhancing filter, low-pass filter, smoothing filter, and/or the like.

Further, when receiving the instruction of the final image filtering process, the filtering part 113 generates a filtered image by performing a desired filtering process, such as a high-frequency enhancing filter, low-pass filter, smoothing filter, and/or the like to the original image given from the reading part 111. The filtering part 113 gives the filtered image thus generated to the writing part 114.

When receiving the instruction of the image generating process, the writing part 114 writes the smallest-scale reduced image given from the reducing part 112 and the N-number of filtered images given from the filtering part 113 into the RAM 13. Further, when receiving the instruction of the final image filtering process, the writing part 114 writes the filtered images given from the filtering part 113 into the RAM 13.

With reference to FIG. 1 again, the CPU 12 serves as a central processing processor that conducts overall control on the image processing apparatus 1. In this embodiment, the CPU 12 controls the processes in the DSP 11 to result in a predetermined number of filtered images. Specifically, the CPU 12 counts the number of execution times of the image generating process, to result in a predetermined number of filtered images. When the number of execution times of the image generating process reaches a predetermined number of times, the CPU 12 instructs the DSP 11 to execute the final image filtering process. For example, when an original image picked up by an imaging apparatus, such as a camera, is stored into the RAM 13, the CPU 12 resets a counter, and increments the counter by one every time the image generating process is executed by the DSP 11. For example, when detecting that the filtered images and the reduced image have been written into the RAM 13 by the DSP 11, the CPU 12 increments the counter by one. Further, in a case where the number of execution times of the image generating process is set to one, six filtered images are generated after the final image filtering process. In a case where the number of execution times of the image generating process is set to two, eleven filtered images are obtained after the final image filtering process. In general, in a case where the number of execution times of the image generating process is set to N (“N” is a natural number), (5N+1)-number of filtered images are obtained after the final image filtering process.

The RAM 13 serves as a memory that stores images. In the RAM 13, the original image and the filtered images and reduced image processed by the DSP 11 are stored. As the RAM 13, a Double-Data-Rate Synchronous Dynamic RAM (DDR SDRAM), Static RAM (SRAM), or the like may be used. Here, the filtered images stored in the RAM 13 are subjected to image processing, such as feature point extraction. Further, a program stored in the ROM 14 is loaded into the RAM 13, and is executed by the DSP 11 or CPU 12.

The ROM 14 stores a program to be executed by the DSP 11 and the CPU 12. For example, the ROM 14 stores a program, such as a program for conducting an image processing method as described later.

The bus 15 serves to transfer data in the form of electric signals, in accordance with a predetermined communication protocol, between the DSP 11, the CPU 12, the RAM 13, and the ROM 14.

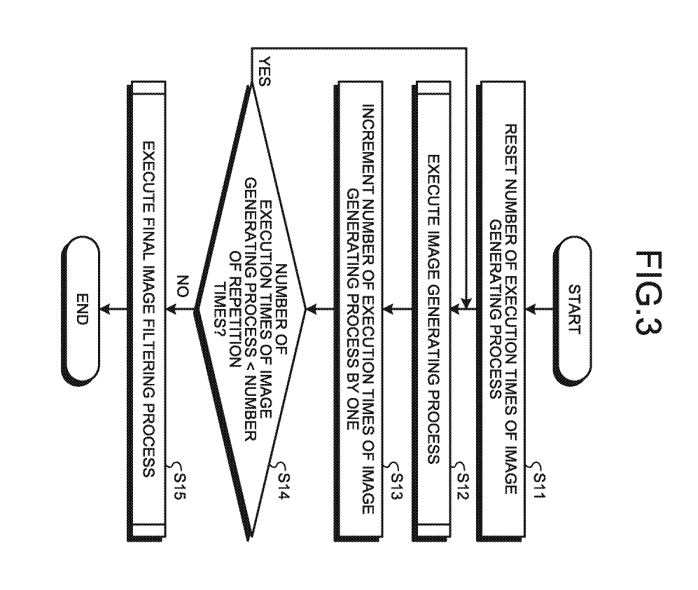

Next, an explanation will be given of an image processing method in the image processing apparatus 1 having the above configuration. FIG. 3 is a flowchart illustrating an example of the sequence of an image processing method according to the embodiment. Here, it is assumed that the number of repetition times of the image generating process is set to M (“M” is a natural number). Further, it is assumed that a state has been made where an original image picked up by an imaging apparatus, such as a camera, is stored at a predetermined address of the RAM 13.

First, when the original image is stored into the RAM 13, the CPU 12 resets a counter that counts the number of execution times of the image generating process (step S11). Then, the CPU 12 instructs the DSP 11 to execute the image generating process with respect to the original image stored in the RAM 13, and the DSP 11 executes the image generating process (step S12).

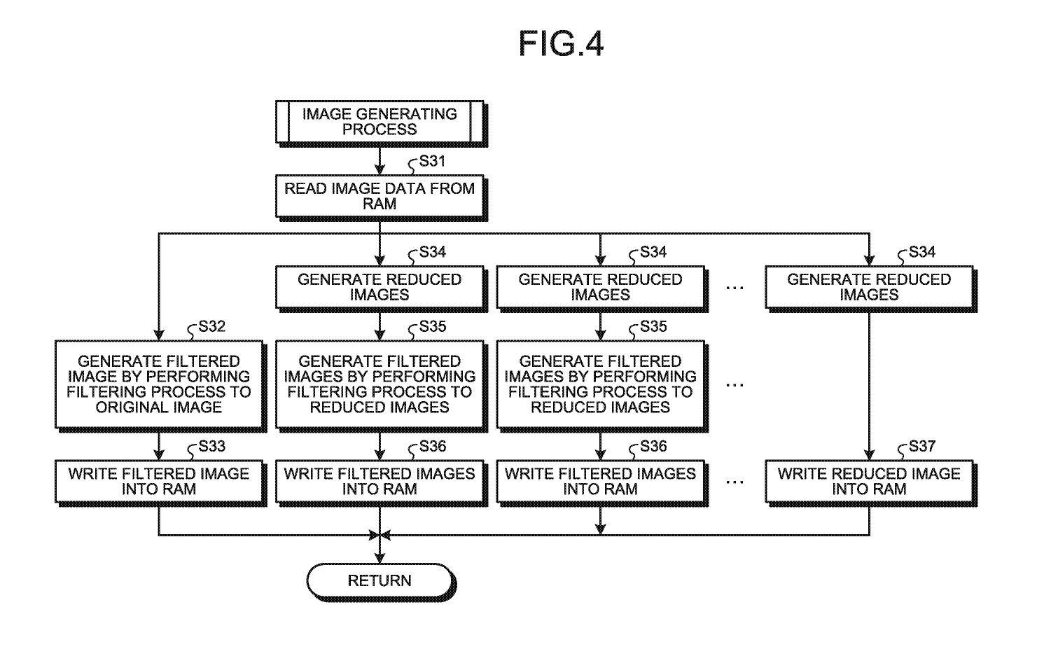

FIG. 4 is a flowchart illustrating an example of the sequence of the image generating process. First, the reading part 111 of the DSP 11 reads image data from a predetermined address of the RAM 13 (step S31). This image data represents an original image not yet subjected to any filtering process. When the value of the counter is zero, the image data stored in the RAM 13 represents an original image picked up by an imaging apparatus, for example. On the other hand, when the value of the counter is other than zero, the image data stored in the RAM 13 represents the smallest-scale reduced image generated by the previous round of the image generating process.

Then, the filtering part 113 of the DSP 11 generates a filtered image by performing a filtering process to the original image thus read (step S32). Thereafter, the writing part 114 of the DSP 11 writes the filtered image obtained by the filtering process into a predetermined address of the RAM 13 (step S33).

Further, the reducing part 112 of the DSP 11 generates N-number of reduced images different in scale, from the original image thus read (step S34). As described above, the scales can be set to arbitrary values. The filtering part 113 of the DSP 11 generates filtered images by performing a filtering process to the (N−1)-number of reduced images excluding the smallest-scale reduced image (step S35). Thereafter, the writing part 114 of the DSP 11 writes the (N−1)-number of filtered images obtained by the filtering process into predetermined addresses of the RAM 13 (step S36). On the other hand, with respect to the smallest-scale reduced image, after a reduced image is generated in step S34, the writing part 114 writes the reduced image into a predetermined address of the RAM 13 (step S37).

Here, the processes to the original image in steps S32 to S33, the processes to the reduced images other than the smallest-scale reduced image in steps S34 to S36, and the processes to the smallest-scale reduced image in steps S34 and S37 are executed in parallel with each other. As a result of the above, the image generating process is completed, and the process flow returns into the flowchart of FIG. 3.

Thereafter, when the filtered images and the reduced image have been written into predetermined addresses of the RAM 13, the CPU 12 increments the counter by one (step S13). In other words, the number of execution times of the image generating process is incremented by one.

Then, the CPU 12 determines whether the value of the counter is smaller than the number of repetition times M (step S14). When the value of the counter is smaller than the number of repetition times M (Yes at step S14), the process flow returns to step S12. In this case, the image generating process comes to be performed with respect to the smallest-scale reduced image written into the RAM 13 by the previous round of the image generating process. Specifically, the CPU 12 instructs the DSP 11 to read the smallest-scale reduced image written in the RAM 13, for which the processes of FIG. 4 are then performed as described above.

On the other hand, when the value of the counter is equal to the number of repetition times M (No at step S14), the final image filtering process is executed (step S15).

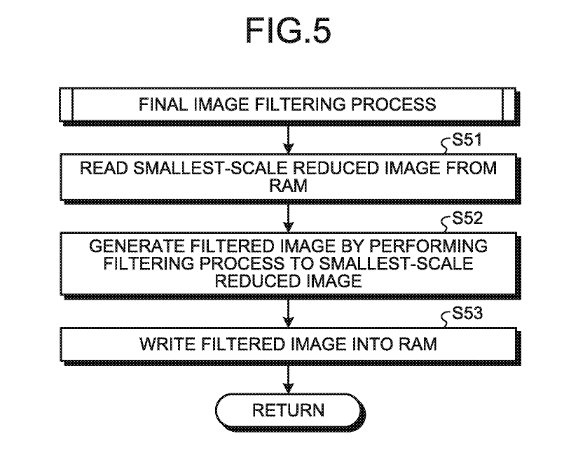

FIG. 5 is a flowchart illustrating an example of the sequence of the final image filtering process. First, the reading part 111 of the DSP 11 reads image data from a predetermined address of the RAM 13 (step S51). Here, the CPU 12 notifies the DSP 11 of an address into which the smallest-scale reduced image has been written by the immediately previous round of the image generating process, and the DSP 11 reads the smallest-scale reduced image from the notified address. Then, the filtering part 113 of the DSP 11 generates a filtered image by performing a filtering process to the smallest-scale reduced image thus read (step S52). Then, the writing part 114 of the DSP 11 writes the filtered image thus generated into a predetermined address of the RAM 13 (step S53). As a result of the above, the final image filtering process is completed, and the flowchart of FIG. 3 is also completed.

In the above description, the CPU 12 has a function for counting the number of execution times of the image generating process. Alternatively, the DSP 11 serving as an image processor may be provided with a function (counting part) for counting the number of execution times of the image generating process.

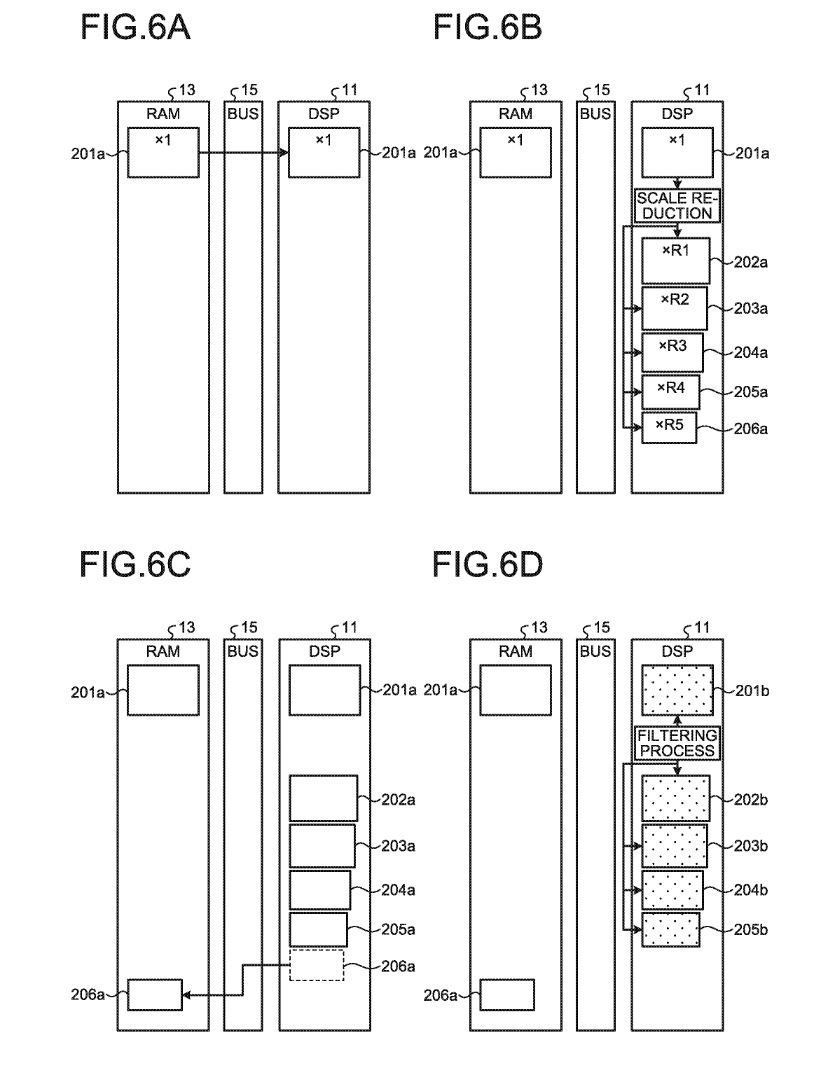

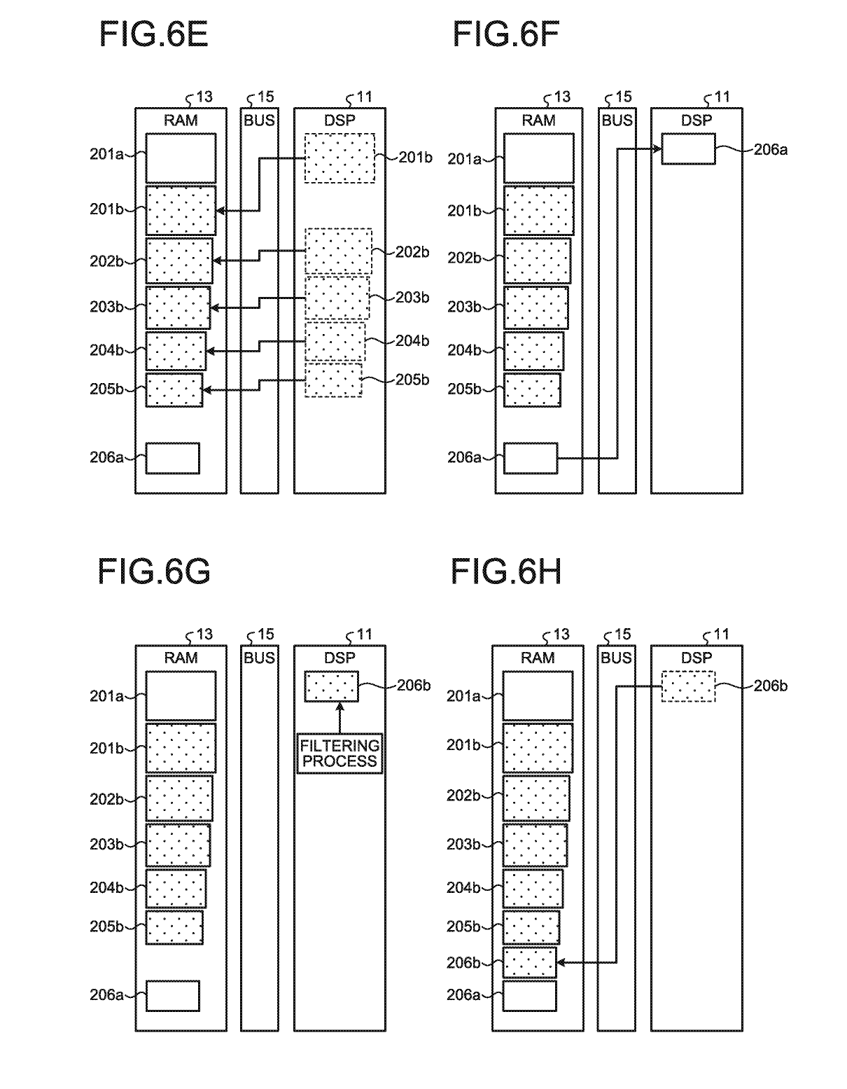

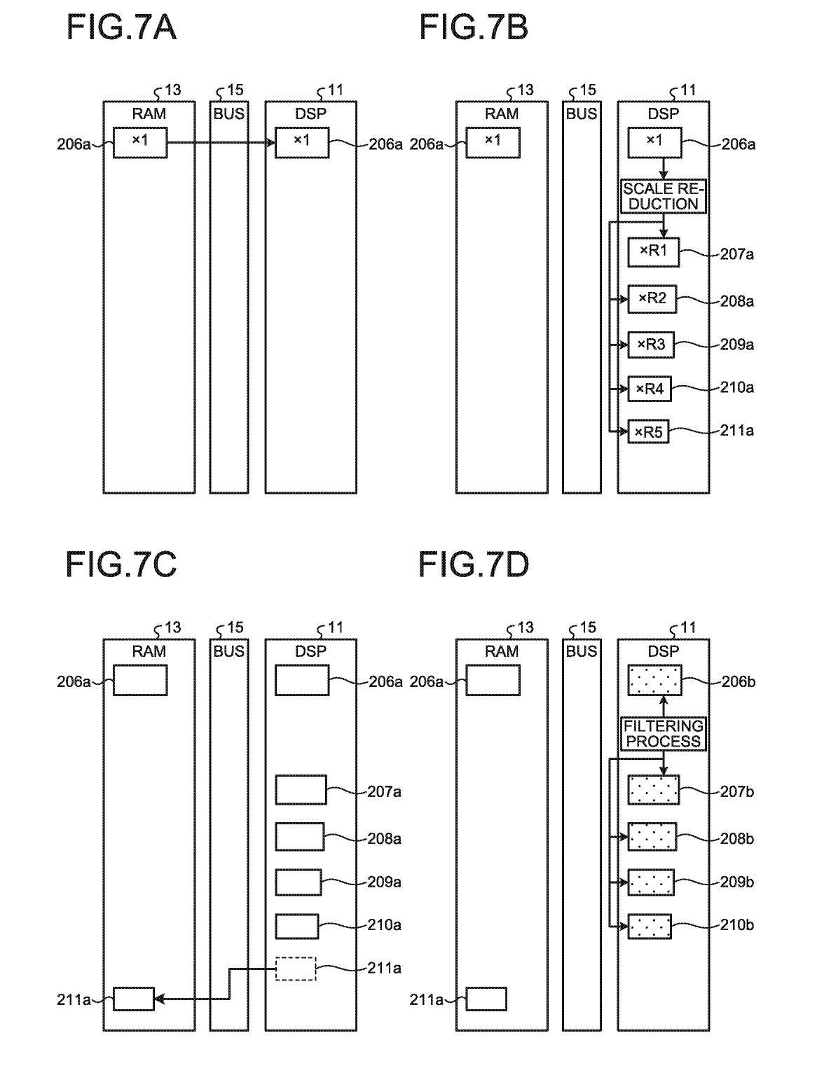

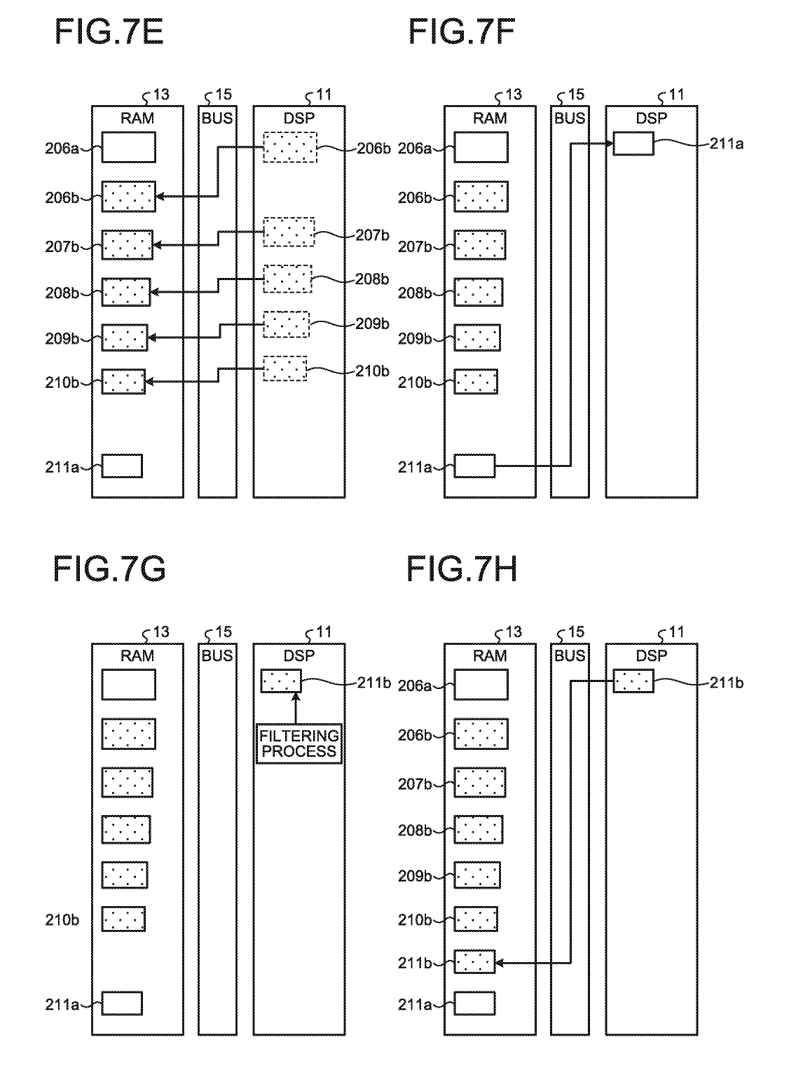

Next, an explanation will be given of an outline of the image processing method. FIGS. 6A to 7H are diagrams schematically illustrating an example of procedures for the image processing method according to the embodiment. This explanation will take as an example a case where the DSP 11 generates five reduced images different in scale, from an original image. Here, FIGS. 6A to 6H illustrate a case where the number of repetition times is one, and FIGS. 7A to 7H illustrate a case where the number of repetition times is more than one. Further, the following explanation will take as an example a case where five reduced images are generated by the image generating process performed once.

<Where the Number of Repetition Times is One>

As illustrated in FIG. 6A, the reading part 111 of the DSP 11 reads an original image 201a from the RAM 13 via the bus 15. Then, as illustrated in FIG. 6B, the reducing part 112 of the DSP 11 generates five reduced images 202a to 206a different in scale factor, from the original image 201a. Specifically, with respect to the original image 201a, the reduced images generated here are a reduced image 202a scaled R1 times, a reduced image 203a scaled R2 times, a reduced image 204a scaled R3 times, a reduced image 205a scaled R4 times, and a reduced image 206a scaled R5 times.

Thereafter, as illustrated in FIG. 6C, the writing part 114 of the DSP 11 writes the smallest-scale reduced image 206a into a predetermined address of the RAM 13 via bus 15.

Further, in parallel with the above, as illustrated in FIG. 6D, the filtering part 113 of the DSP 11 performs a filtering process to each of the original image 201a and the reduced images 202a to 205a excluding the smallest-scale reduced image 206a. Consequently, filtered images 201b to 205b are generated. Then, as illustrated in FIG. 6E, the writing part 114 of the DSP 11 writes the filtered images 201b to 205b thus generated into predetermined addresses of the RAM 13 via the bus 15.

In this example, as the number of repetition times is one, the above is all for the image generating process. Thereafter, the final image filtering process is performed. As illustrated in FIG. 6F, the reading part 111 of the DSP 11 reads the smallest-scale reduced image 206a via the bus 15. Then, as illustrated in FIG. 6G, the filtering part 113 of the DSP 11 generates a filtered image 206b by performing a filtering process to the reduced image 206a thus read. Then, as illustrated in FIG. 6H, the writing part 114 of the DSP 11 writes the filtered image 206b thus generated into a predetermined address of the RAM 13 via the bus 15. As a result of the above, six filtered images are obtained, which include a filtered image equal in scale to the original image.

<Where the Number of Repetition Times is More than One>

Even where the number of repetition times is more than one, it follows the same procedures as those of FIGS. 6A to 6E described for the case where the number of repetition times is one. Thereafter, the CPU 12 (not illustrated) counts the number of repetition times, and, as illustrated in FIG. 7A, the reading part 111 of the DSP 11 reads the smallest-scale reduced image 206a via the bus 15 from the address of the RAM 13 into which the reduced image 206a has been written by the previous round of the image generating process. Thus, the reduced image 206a is used as a new original image.

Then, as illustrated in FIG. 7B, the reducing part 112 of the DSP 11 generates five reduced images 207a to 211a different in scale factor, from the original image 206a. Specifically, with respect to the original image 206a, the reduced images generated here are a reduced image 207a scaled R1 times, a reduced image 208a scaled R2 times, a reduced image 209a scaled R3 times, a reduced image 210a scaled R4 times, and a reduced image 211a scaled R5 times. Thus, as compared with the root original image 201a, the reduced images 207a to 211a generated here are with scales of R5×R1 times, R5×R2 times, R5×R3 times, R5×R4 times, and R5×R5 times, respectively.

Thereafter, as illustrated in FIG. 7C, the writing part 114 of the DSP 11 writes the smallest-scale reduced image 211a into a predetermined address of the RAM 13 via the bus 15.

Further, in parallel with the above, as illustrated in FIG. 7D, the filtering part 113 of the DSP 11 performs a filtering process to each of the original image 206a and the reduced images 207a to 210a excluding the smallest-scale reduced image 211a. Consequently, filtered images 206b to 210b are generated. Then, as illustrated in FIG. 7E, the writing part 114 of the DSP 11 writes the filtered image 206b to 210b thus generated into predetermined addresses of the RAM 13 via the bus 15.

Where the number of repetition times is three or more, the procedures of FIGS. 7A to 7E are performed in accordance with the number of repetition times. However, in this example, it is assumed that the number of repetition times is two. Then, when the number of repetition times reaches a preset number of times, as illustrated in FIG. 7F, the reading part 111 of the DSP 11 reads the smallest-scale reduced image 211a via the bus 15. Then, as illustrated in FIG. 7G, the filtering part 113 of the DSP 11 generates a filtered image 211b by performing a filtering process to the reduced image 211a thus read. Then, as illustrated in FIG. 7H, the writing part 114 of the DSP 11 writes the filtered image 211b thus generated into a predetermined address of the RAM 13 via the bus 15. As a result of the above, eleven filtered images 201b to 211b are obtained, which include a filtered image 201b equal in scale to the original image 201a read in FIG. 6A.

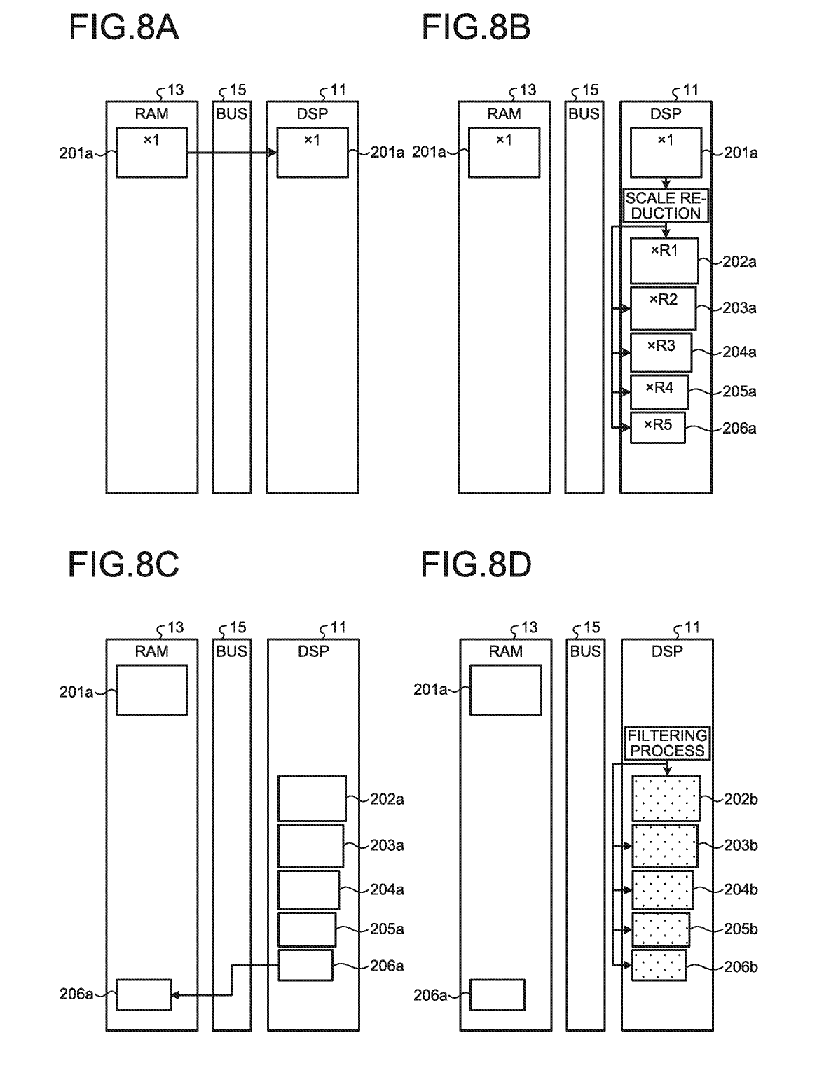

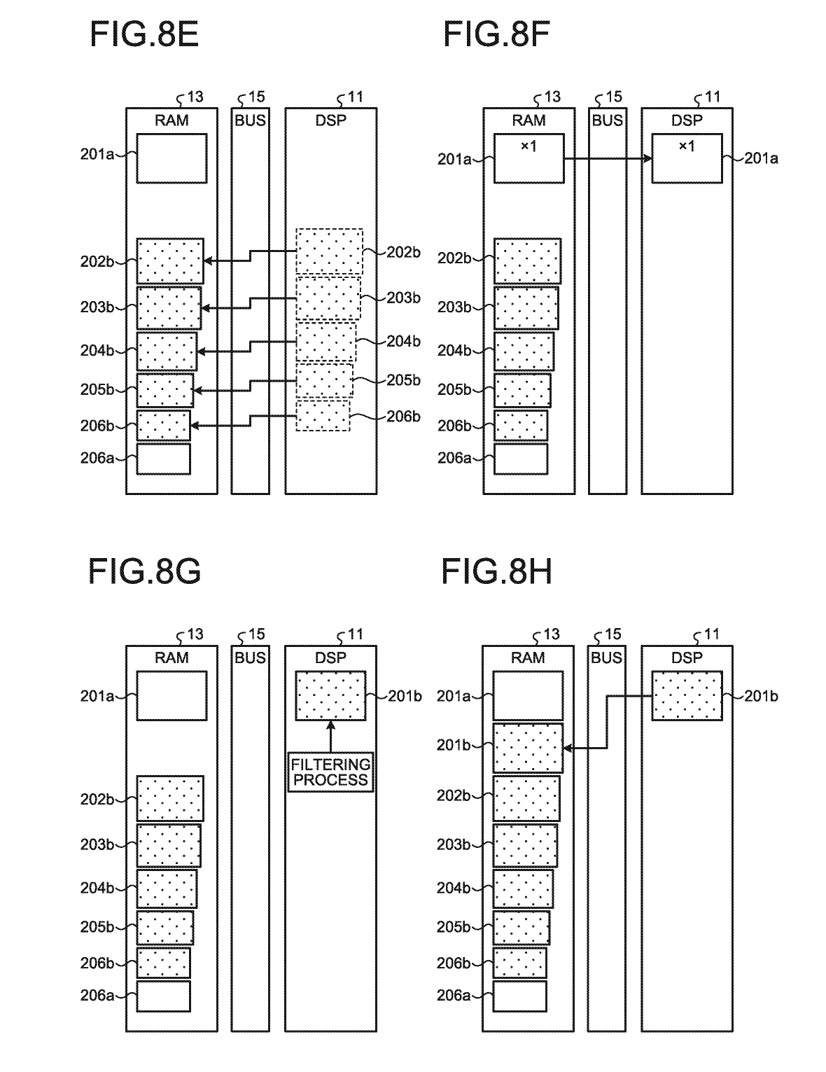

Here, an explanation will be given of an effect of this embodiment in comparison with a comparative example. FIGS. 8A to 8H are diagrams schematically illustrating an example of procedures for an image processing method according to a comparative example. This explanation will take as an example a case where the DSP 11 generates five reduced images different in scale, from an original image.

As illustrated in FIG. 8A, the DSP 11 reads an original image 201a from the RAM 13 via the bus 15. Then, as illustrated in FIG. 8B, the DSP 11 generates five reduced images 202a to 206a different in scale factor, from the original image 201a. Specifically, with respect to the original image 201a, the reduced images generated here are a reduced image 202a scaled R1 times, a reduced image 203a scaled R2 times, a reduced image 204a scaled R3 times, a reduced image 205a scaled R4 times, and a reduced image 206a scaled R5 times.

Thereafter, as illustrated in FIG. 8C, the DSP 11 writes the smallest-scale reduced image 206a into a predetermined address of the RAM 13 via bus 15.

Further, in parallel with the above, as illustrated in FIG. 8D, the DSP 11 performs a filtering process to each of the reduced images 202a to 206a. Consequently, filtered images 202b to 206b are generated. Then, as illustrated in FIG. 8E, the DSP 11 writes the filtered images 202b to 206b thus generated into predetermined addresses of the RAM 13 via the bus 15.

Where the number of repetition times is one, thereafter, as illustrated in FIG. 8F, the DSP 11 reads via the bus 15 the original image 201a, which is the same as that read in FIG. 8A. Then, as illustrated in FIG. 8G, the DSP 11 generates a filtered image 201b by performing a filtering process to the original image 201a thus read. Then, as illustrated in FIG. 8H, the DSP 11 writes the filtered image 201b thus generated into a predetermined address of the RAM 13 via the bus 15. As a result of the above, six filtered images are obtained, which include a filtered image equal in scale to the original image.

As illustrated in FIGS. 8A and 8F, according to the comparative example, the original image 201a, which is larger in size as compared with the reduced images, are read twice, from the RAM 13 into the DSP 11 through the bus 15. Accordingly, a certain time is required to perform the image processing and a certain load is imposed on the bus 15 during the transfer.

On the other hand, according to this embodiment, where the number of repetition times is one, the original image 201a is transferred from the RAM 13 to the DSP 11 via the bus 15. Further, thereafter, when the final image filtering process is executed, the smallest-scale reduced image among the images obtained by scale reduction of the original image is transferred from the RAM 13 to the DSP 11 via the bus 15. Thus, as compared with the comparative example, the size of the image data transmitted for the second time becomes smaller. Consequently, it is possible to shorten the time necessary for transferring image data, i.e., the time necessary for image processing, as compared with the comparative example, and to reduce the load imposed on the bus 15 during the transfer, as compared with the comparative example.

An image processing program to be executed by the image processing apparatus according to this embodiment is provided in a state recorded in a computer-readable recording medium, such as a Compact Disc (CD)-ROM, flexible disk (FD), CD Recordable (CD-R), or Digital Versatile Disc (DVD), by a file in an installable format or executable format.

Alternatively, an image processing program to be executed by the image processing apparatus according to this embodiment may be provided such that the program is stored in a computer connected to a network, such as the internet, and is downloaded via the network. Further, an image processing program to be executed by the image processing apparatus according to this embodiment may be provided such that the program is provided or distributed via a network, such as the internet.

Alternatively, an image processing program according to this embodiment may be provided in a state incorporated in an ROM or the like in advance.

An image processing program to be executed by the image processing apparatus according to this embodiment is formed in a module configuration that contains the respective parts described above (the reading part 111, reducing part 112, filtering part 113, and writing part 114). For actual hardware, the DSP 11 (processor) reads the image processing program from a storage medium, such as one described above, and executes the program to load the respective parts described above into the main storage device. Consequently, the reading part 111, the reducing part 112, the filtering part 113, and the writing part 114 are generated in the main storage device.

Further, in the above description, an explanation has been given of a case where the DSP 11 reads an image processing program, to execute the image processing method described above. However, in place of the DSP 11, an IPA (Image Processing Accelerator) may be used, which executes the image processing method described above by using not software but hardware. The IPA is composed of a circuit for executing the image processing method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a memory storing an image;
an image processor performing a reducing or filtering process to the image read from the memory; and
a bus transferring the image between the memory and the image processor, wherein
the image processor executes an image generating process and a final image filtering process,
the image generating process includes reading a first image from the memory; generating N-number of reduced images different in scale (“N” is a natural number of 2 or more), from the first image; writing a first reduced image with a smallest scale of the reduced images into the memory; generating first filtered images by performing the filtering process to the first image and to a second reduced image or second reduced images of the reduced images excluding the first reduced image; and writing the first filtered images into the memory, and
the final image filtering process includes reading the first reduced image from the memory; generating a second filtered image by performing the filtering process to the first reduced image; and writing the second filtered image into the memory.

2. The image processing apparatus according to claim 1, further comprising a central processing processor, wherein
the central processing processor counts a number of execution times of the image generating process, causes the image processor to execute the image generating process when the number of execution times is less than a predetermined number of repetition times, and causes the image processor to execute the final image filtering process when the number of execution times reaches the number of repetition times.

3. The image processing apparatus according to claim 2, wherein, when the number of repetition times is two or more, the image processor executes a second or subsequent round of the image generating process, by reading as the first image the first reduced image written into the memory by an immediately previous round of the image generating process.

4. The image processing apparatus according to claim 1, wherein the image processor counts a number of execution times of the image generating process, executes the image generating process when the number of execution times is less than a predetermined number of repetition times, and executes the final image filtering process when the number of execution times reaches the number of repetition times.

5. The image processing apparatus according to claim 4, wherein, when the number of repetition times is two or more, the image processor executes a second or subsequent round of the image generating process, by reading as the first image the first reduced image written into the memory by an immediately previous round of the image generating process.

6. The image processing apparatus according to claim 1, wherein the image processor is a digital signal processor in which procedures of the image generating process and procedures of the final image filtering process are incorporated as a program.

7. The image processing apparatus according to claim 1, wherein the image processor is a circuit configured to execute the image generating process and the final image filtering process.

8. An image processing method to be executed by an image processing apparatus that includes
a memory storing an image,
an image processor performing a reducing or filtering process to the image read from the memory, and
a bus transferring the image between the memory and the image processor,
the image processing method comprising:
reading a first image from the memory;
generating N-number of reduced images different in scale (“N” is a natural number of 2 or more), from the first image;
writing a first reduced image with a smallest scale of the reduced images into the memory;
generating first filtered images by performing the filtering process to the first image and to a second reduced image or second reduced images of the reduced images excluding the first reduced image;
writing the first filtered images into the memory;
reading the first reduced image from the memory;
generating a second filtered image by performing the filtering process to the first reduced image; and
writing the second filtered image into the memory.

9. The image processing method according to claim 8, further comprising:
counting a number of execution times of a process from the reading the first image to the writing the first filtered images; and
determining whether the number of execution times reaches a predetermined number of repetition times, wherein
the process from the reading the first image to the writing the first filtered images is executed, when the number of execution times is less than the predetermined number of repetition times; and
a process from the reading the first reduced image to the writing the second filtered image is executed, when the number of execution times reaches the predetermined number of repetition times.

10. The image processing method according to claim 9, wherein
when the number of repetition times is two or more,
the first image to be read in the reading the first image is the first reduced image written by an immediately previous round of the writing a first reduced image, and
in the reading of the first reduced image, the first reduced image written by the immediately previous round of the writing the first reduced image is read.
